(19) United States
(12) Patent Application Publication
(10) Pub. No.: US 2017/0324777 A1
(43) Pub. Date: Nov. 9, 2017

(54) INJECTING SUPPLEMENTAL DATA INTO DATA QUERIES AT NETWORK END-POINTS

(71) Applicant: Javelin Networks, Inc., Palo Alto, CA (US)

(72) Inventors: Almog Ohayon, Tel Aviv (IL); Guy Franco, Tel Aviv (IL); Roi Abutbul, Be'er Sheva (IL)

(21) Appl. No.: 15/649,512

(22) Filed: Jul. 13, 2017

Related U.S. Application Data
(63) Continuation-in-part of application No. 15/637,765, filed on Jun. 29, 2017.
Application No. 15/637,765 is a continuation-in-part of application No. 15/588,280, filed on May 5, 2017.
(60) Provisional application No. 62/361,660, filed on Jul. 13, 2016.
(60) Provisional application No. 62/356,391, filed on Jun. 29, 2016.
(60) Provisional application No. 62/332,264, filed on May 5, 2016.

(51) Int. Cl. H04L 29/06; G06F 17/30

(52) U.S. Cl. CPC H04L 63/1491; G06F 17/30864; H04L 63/1425

(57) ABSTRACT

Various embodiments pertain to techniques for injecting supplemental data into search query results delivered to an operating system. More specifically, an operating system can submit a search query to a directory server (or some other network-accessible database), and then pass results of the search query to a local proxy. The local proxy can inject supplemental data into the results. For example, the local proxy could inject bogus user account information in an effort to obfuscate an unauthorized entity who attempts to penetrate the network by parsing the results of the search query.

### CROSS-REFERENCE TO RELATED APPLICATIONS

This application claims priority to U.S. Provisional Application No. 62/361,660, entitled “Injecting Supplemental Data into Data Queries at Network End-points, and filed Jul. 13, 2016. This application, is a continuation-in-part of U.S. patent application Ser. No. 15/637,765, entitled “Artificial Intelligence (AI) Techniques for Learning and Modeling Internal Networks,” and filed on Jun. 29, 2017, which claims priority to U.S. Provisional Application No. 62/356,391, entitled “Artificial Intelligence (AI) Techniques for Learning and Modeling Internal Networks,” and filed on Jun. 29, 2016. This application is also a continuation-in-part of U.S. patent application Ser. No. 15/588,280, entitled “Creation of Fictitious Identities to Obfuscate Hacking of Internal Networks,” and filed May 5, 2017, which claims priority to U.S. Provisional Application No. 62/332,264, entitled “Creation of Ambiguous Identities to Obfuscate Hacking of Internal Networks,” and filed May 5, 2016. The content of the above-identified applications are incorporated herein by reference in their entirety.

### FIELD OF THE INVENTION

Various embodiments concern computer-implemented security techniques and, more specifically, injection of supplemental data into the results of a data query to obfuscate a hacker attempting to access sensitive data.

### BACKGROUND

A computer network (also referred to simply as a “network”) is a collection of hardware components and computing devices that are interconnected by communication channels that allow data and resources to be shared. Home networks (e.g., residential Local Area Networks) are typically used for communication between computing devices installed or used in a home, such as printers, tablets, and mobile phones. Enterprise networks, meanwhile, normally enable employees to access vital programs and data that are necessary for the day-to-day operations of an enterprise (e.g., a company).

However, enterprise networks are often an attractive target for unauthorized parties or entities (also referred to as “hackers”) and need to be protected. Each network computing device, such as an end-point device or a server, creates a potential entry point for security threats.

### BRIEF DESCRIPTION OF THE DRAWINGS

While the accompanying drawings include illustrations of various embodiments, the drawings are not intended to limit the claimed subject matter.

FIG. 1 is a generalized illustration of an internal (e.g., enterprise) network.

FIG. 2 is a generalized illustration of the internal network after a deception module is installed on a computing device in the internal network.

FIG. 3A depicts a process by which a computing device on a network may inject supplemental data into a response to a data query.

FIG. 3B depicts a process by which a local proxy can detect malicious acts by monitoring whether an unauthorized party (e.g., a hacker) attempts to use any of the injected supplemental data.

FIG. 4 depicts a flow diagram of a process at a network computing device for injection of supplemental data into the results of a data query.

FIG. 5 is a block diagram illustrating an example of a computer system in which at least some operations described herein can be implemented.

The figures depict various embodiments described throughout the Detailed Description for the purposes of illustration only. While specific embodiments have been shown by way of example in the drawings and are described in detail below, the invention is amenable to various modifications and alternative forms. The intention is not to limit the invention to the particular embodiments described. Accordingly, the claimed subject matter is intended to cover all modifications, equivalents, and alternatives falling within the scope of the invention as defined by the appended claims.

### DETAILED DESCRIPTION

Various embodiments are described herein that relate to security techniques for internal (e.g., enterprise) networks and systems that are accessible only to a limited set of authorized users (e.g., employees of the enterprise). Network enumeration (user enumeration and guessable user account) is a technique commonly used by an unauthorized party (e.g., a hacker) to identify a list of valid usernames and information on groups, shares, and services of networked computers. Network enumeration can use discovery protocols such as Internet Control Message Protocol (ICMP) and Simple Network Management Protocol (SNMP) to gather information.

A network enumerator or network scanner is a computer program used to retrieve usernames and info on groups, shares, and services of networked computers. This type of program scans networks for vulnerabilities in the security of that network. If there is a vulnerability with the security of the network, it can send a report back to a hacker who may use this info to exploit that network glitch to gain entry to the network or for other malicious activities.

Malicious hackers can, on entry of the network, get to security-sensitive information or corrupt the network making it useless. If this network belonged to a company that used this network on a regular basis, the company would lose the function to send information internally to other departments. Often, web applications reveal when a username exists on system, either as a consequence of a misconfiguration or as a design decision. For example, if incorrect credentials are submitted, a message may be generated that states that either the username is present on the system or the provided password is wrong. The information obtained can be used by an attacker to gain a list of users on the system. This information can be used to attack the web application, for example, through a brute force or default username/password attack.

In at least one embodiment, a technique can be used to inject supplemental data (e.g., false information, such as bogus user account information) into the results of a data query, such as a user account enumeration query, at a computing device on a network.

For example, the operating system of a server could be modified to change its default behavior for a user account enumeration query. A hacker's request using supplemental data (attempt to login using supplemental data) can be used to identify that request as malicious.

In an example, the operating system of a server on a network forwards a user account enumeration query to a directory server, which returns a query response. The default behavior of the operating system can be modified so that the operating system diverts the query response to a local proxy, rather than return the query response directly to the server. The local proxy can then supplement the query response data with additional information before returning the query results to the operating system of the server. For example, the local proxy could inject false information (e.g., bogus user account information) that is intended to obfuscate a party (e.g., a hacker) that subsequently reviews the modified query results. Such action may be used as part of a technique for securing the network.

In some embodiments, additional security protections (also referred to as “security layers”) can be implemented by the local proxy for detecting unpermitted and/or malicious conduct of an unauthorized party (e.g., a hacker). After the query response has been manipulated by the local proxy, the unauthorized party may attempt to use one of the deceptive computer elements introduced by the local proxy into the query response. The operating system of the server can be configured to automatically create a Domain Name System (DNS) query in response to determining the unauthorized party has attempted to use a deceptive computer element, and then transmit the DNS query to a DNS server. When the DNS server returns a DNS response that includes a failure header, the DNS response can be redirected to the local proxy, which determines whether the sought-after computer element was one of the deceptive elements created by the local proxy. If so, the local proxy can create a record of the event failure that is subsequently analyzed.

Note that such a technique could make use of some security protocols that are already executed by the operating system of the server and not enabled by the local proxy (e.g., the server may already be configured to automatically create the failure event in response to determining the sought-after element does not exist). Moreover, while reference may be made to certain network end points in various examples (e.g., a server), one skilled in the art will recognize that the techniques described herein are equally applicable to other network end points.

Techniques such as those discussed above may be used to protect an internal network from both external and internal attacks (e.g., as part of a proprietary deception technique developed for a particular environment, such as a Microsoft Windows® operating system, Apple OS X® operating system, or Linux-based operating system). For example, because a hacker may not be able to distinguish between original query response and a query response with supplemental data, any further attempt by the hacker to enter the network using the supplemental data (e.g., a bogus user account) can be screened and flagged for security administrators. For example, if a supplemental data “Tom.Jones” account is used in an attempt to log into the system, that attempt will be flagged. In at least one embodiment information is collected about the flagged attempt such as the IP address, operating system, MAC address, etc. Oftentimes, such techniques will be tailored for one or more particular environments. However, some elements of the techniques are transferrable across different environments, types of internal networks, network topologies, etc.

Various embodiments are described with reference to system configurations or networks for enterprises (e.g., companies) for convenience. However, one skilled in the art will recognize that features described herein are equally applicable to other system configurations, network types, etc. Moreover, the techniques introduced herein can be embodied as special-purpose hardware (e.g., circuitry), programmable circuitry appropriately programmed with software and/or firmware, or as a combination of special-purpose and programmable circuitry. Hence, embodiments may include a machine-readable medium having stored thereon instructions which may be used to program a computer (or some other computing device) to perform a process. The machine-readable medium may include, but is not limited to, floppy diskettes, optical disks, compact disk read-only memories (CD-ROMs), magneto-optical disks, read-only memories (ROMs), random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

### Terminology

Brief definitions of terms, abbreviations, and phrases used throughout this application are given below.

References in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described that may be exhibited by some embodiments and not by others. Similarly, various requirements are described that may be requirements for some embodiments but not others.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. For example, two devices may be coupled directly, or via one or more intermediary channels or devices. As another example, devices may be coupled in such a way that information can be passed there between, while not sharing any physical connection with one another. Additionally, the words “herein,” “above,” “below,” and words of similar import, when used in this application, shall refer to this application as a whole and not to any particular portions of this application. Where the context permits, words in the Detailed Description using the singular or plural number may also include the plural or singular number respectively. The word “or,” in reference to a list of two or more items, covers all of the following interpretations of the word: any of the items in the list, all of the items in the list, and any combination of the items in the list.

If the specification states a component or feature “may,” “can,” “could,” or “might” be included or have a characteristic, that particular component or feature is not required to be included or have the characteristic.

The term “module” refers broadly to software, hardware, or firmware (or any combination thereof) components. Modules are typically functional components that can generate useful data or other output using specified input(s). A module may or may not be self-contained. An application program (also called an “application”) may include one or more modules, or a module can include one or more application programs.

The term “cause” and variations thereof broadly refer to either direct causation or indirect causation. For example, a computer system can “cause” an action by sending a message to a second computer system that commands, requests, or prompts the second computer system to perform the action. Any number of intermediary devices may examine and/or relay the message during this process. In this regard, a device can “cause” an action even though it may not be known to the device whether the action will ultimately be executed.

Any references to sending or transmitting a message, signal, etc., to another device (recipient device) broadly mean that the message is sent with the intention that its information content ultimately will be delivered to the recipient device; hence, such references do not mean that the message must be sent directly to the recipient device. That is, unless stated otherwise, there can be one or more intermediary entities that receive and forward the message/signal, either “as is” or in modified form, prior to its delivery to the recipient device. This clarification also applies to any references herein to receiving a message/signal from another device; i.e., direct point-to-point communication is not required unless stated otherwise herein.

The terminology used in the Detailed Description is intended to be interpreted in its broadest reasonable manner, even though it is being used in conjunction with certain examples. The terms used in this specification generally have their ordinary meanings in the art, within the context of the disclosure, and in the specific context where each term is used. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, and special significance is not to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

### System Topology Overview

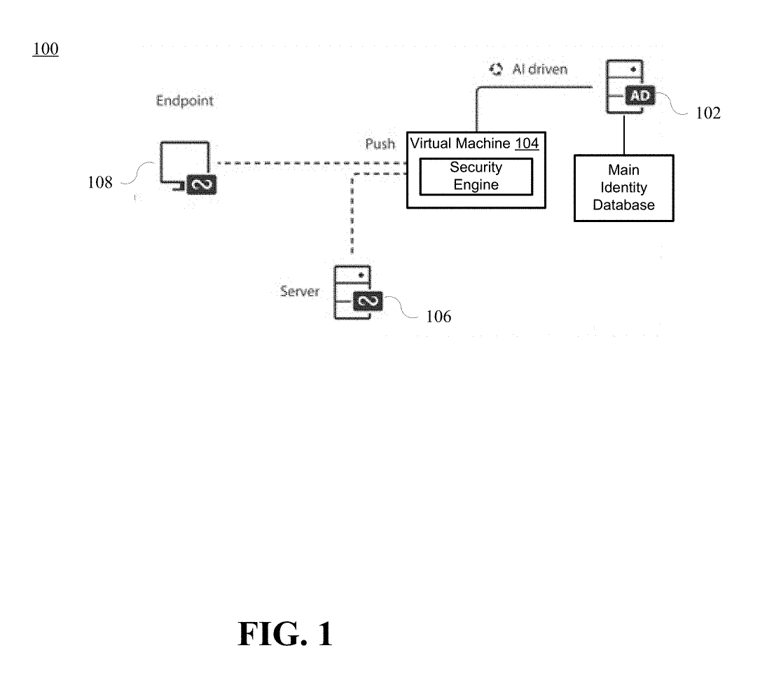

FIG. 1 is a generalized illustration of an internal (e.g. enterprise) network 100. In some embodiments, the internal network 100 is accessible only to a limited set of authorized users (e.g., employees of the enterprise), each of whom has at least one valid identity stored on a directory server 102. More specifically, the directory server 102 (which may be associated with the enterprise) can include a main identity database that is used to facilitate a directory service for the internal network 100. For example, the directory server 102 could be an Active Directory (AD) server if the internal network 100 is a Microsoft Windows-based network. The directory server 102 (and, more specifically, the main identity database) is accessible to compute devices that include servers 106 and end-point 108 that reside within the internal network 100. The directory server 102 includes identities for all authorized users of the internal network 100 and thus is able to supply the user account information in response to a query.

The directory server 102 is accessible to a virtual machine 104 that includes one or more security programs/routines for creating supplemental data for the internal network 100. The virtual machine 104 can read elements (e.g., computer and users' metadata) from the main identity database of the directory server 102 in order to create the supplemental data for the internal network 100. In one embodiment, the main identity database can be left unchanged (i.e., the virtual machine 104 uses the main identity database as a read-only element for modeling).

In at least one embodiment, the main identity database can be updated to include supplemental data. The supplemental data can also be stored separately and used to determine which data in the main identity database is not supplemental data. For example, if the main identity database includes records A, B, and C, and separately stored supplemental data includes record C, it can be determined that the main identity database record A and record B are non-supplemental data records. In at least one embodiment, supplemental data records can include an indicator marking said data record as fictitious. For example the fictitious element may not be associated with any permissions and/or include a flag indicating that it is fictitious.

The supplemental data can be data which is fictitious and mirrors the format of valid records thereby being indistinguishable to unauthorized parties or entities. For example, if the valid data includes username in a format of first name followed by a last name (e.g., tomjohnson) then the fictitious data can follow the same format. Modeling techniques can be used to generate supplemental data. Modeling can be driven by a security engine that learns the characteristics of the internal network 100. The security engine can model the network elements (e.g., authorized identities for valid users) and create supplemental data. Each column and row can be analyzed to determine the appropriate information to generate. For example, the records of a table having an age field can be analyzed and it can be determined that the age range of the valid records are 21-96. Supplemental data records can be created with an age field value that falls within the determined range of 21-96. Patterns within data records can also be analyzed. For example, if the main identity database includes each valid record associated with the network security department being associated with administrative rights, it can be determined that these two fields correlated and therefore supplemental data which is associated with the network security department must also be associated with administrative rights. In at least one embodiment, the rights given to the fictitious account include only rights to a sandbox system that mimics the targeted system.

In at least one embodiment, data can be chosen from the valid records and modified to create new supplemental records. The data can be modified by editing a name and/or one or more letters of the user name. For example, if a valid record account name is “tom1,” then a fictitious data account can be created by modifying one letter to “tim1.”

In some embodiments, machine learning algorithms can be used to determine a pattern of usernames such as whether the usernames include dots between first and last name, whether the format includes first initial followed by a last name and/or whether the format includes the first name followed by the last name. A list of common names (i.e., Kelly, Jim, Jen, John, Tom, etc.) can be stored and used to modify user credentials. For example, if a valid record includes “tomjohnson, administrator, PAO,” the format can be determined and a new supplemental record can be created by changing the first name “jimjohnson, administrator, NYC.” In at least one embodiment, the arrangement of characters are analyzed to determine the format. In at least one embodiment, the supplemental records can include an associated password which is easy to guess and/or having low password strength. For example, the password associated with the fictitious user “jimjohnson” can be set to “password.” A password having a low password strength can be a password that is easy to crack. In an embodiment, the hacker using the fictitious user account can be allowed to log into the network so that the hacker's behavior can be monitored and/or more information can be determined about the hacker. The network into which the hacker can be permitted to log in can be a network that mimics the network which the hacker is attempting to penetrate.

In at least one embodiment where the hacker is permitted to log into the network with the fictitious account, the fictitious account can be associated with a separate server or grouping of servers (i.e., sandbox) uniquely designed for hackers. The separate server can be monitored to gain insight into the behavior of the hacker. The sandbox can be implemented by creating an environment that mimics and/or replicates the targeted environment. Monitored behavior can include directories accessed by the hacker, information about queries attempted by the hacker, information about the hacker such as operating system and IP address, etc. For example, when a hacker logs into the network with the fictitious credentials “jimjohnson,” the hacker can be given access to only the sandbox where the hacker's behavior can be monitored.

The supplemental data may include false information, such as bogus user accounts, that can then be installed/injected into computing devices (e.g., server 106 and endpoint 108) that reside within the internal network 100. In the example, the “jimjohnson” fictitious account can be injected into the same location as the valid accounts are stored on the computing devices.

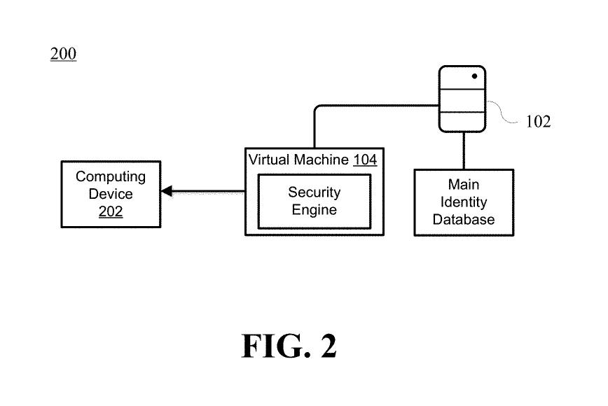

FIG. 2 is a generalized illustration of an internal (e.g. enterprise) network 200 after a deception module is installed on a computing device 202 in the internal network. A service external to the computing device 202, such as the virtual machine 104, can physically or virtually install the deception module on the computing device. The deception module may include changes to the process in the operating system of the computing device that responds to a user account enumeration query, along with any supplemental data manufactured by the external service. The supplemental data may include false information such as bogus user account information. In some cases, the operating system of the computing device will have read-only access to the supplemental data.

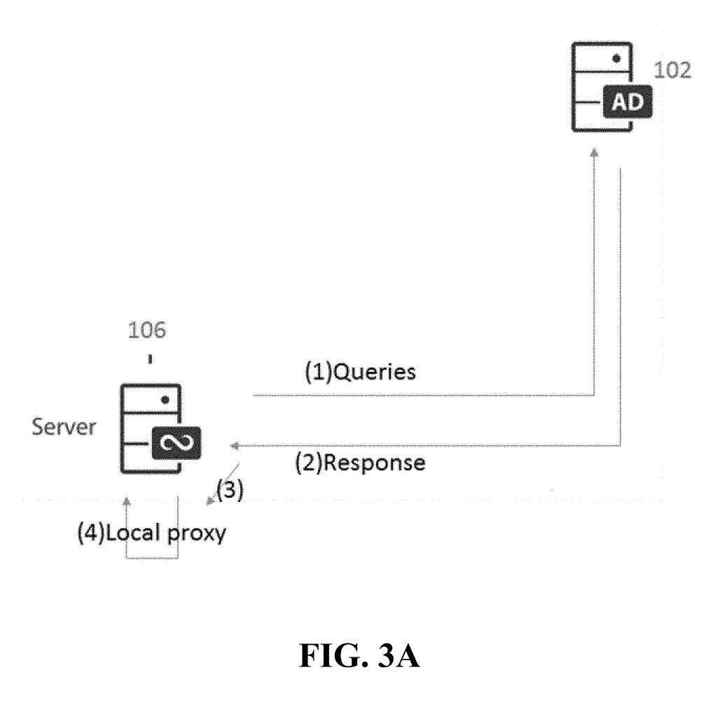

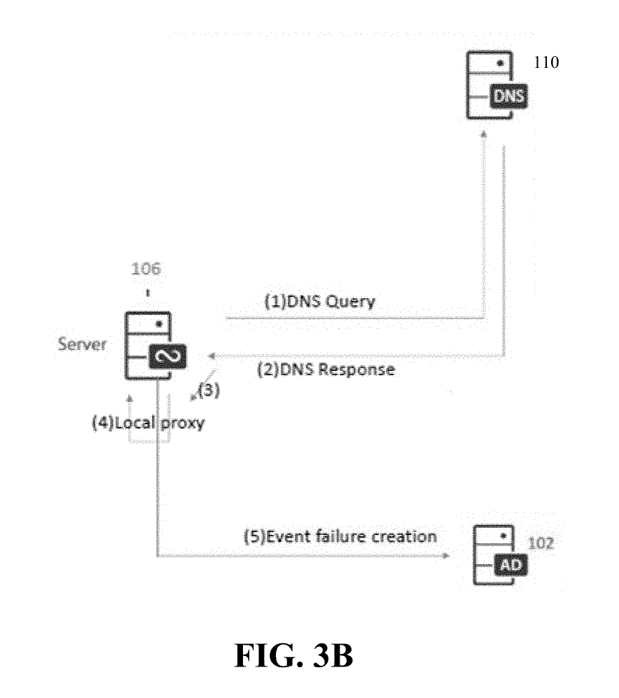

FIG. 3A depicts a process by which a computing device on a network, such as a server 106, may inject supplemental data into a response to a data query. The server 106 may initially send the data query, such as a user account enumeration query, over to the directory server 102. When the directory server 102 responds, the operating system of the server 106 may direct the response to the deception module (e.g., a local proxy). The local proxy can add the supplemental data that may include false information to the response, and then send the modified response back to the operating system of the computing device.

If the internal network is a Microsoft Windows® network, a user account enumeration query can be processed by a Security Accounts Manager (SAM) Enumeration process. The SAM Enumeration process may be implemented using Dynamic Link Libraries (DLLs) and Application Programming Interfaces (APIs) specific to a Microsoft Windows® operating system. The SAM Enumeration process may use a network protocol, such as a Server Message Block (SMB) protocol hosted by Transmission Control Protocol (TCP), to communicate the query to an Active Directory (AD) server. The response from the AD server may be redirected to a local proxy that injects supplemental data into the response generated by the AD server. The supplemental data may include any type of supplemental information (e.g., false information such as bogus identities).

FIG. 3B depicts a process by which a local proxy can detect malicious acts by monitoring whether an unauthorized party (e.g., a hacker) attempts to use any of the injected supplemental data. Additional security protections (also referred to as “security layers”) can be implemented by the local proxy for detecting unpermitted and/or malicious conduct of the unauthorized party.

More specifically, after the response to the data query has been manipulated (e.g., by the local proxy), the unauthorized party may attempt to use some or all of the supplemental data injected into the response. For example, the unauthorized party could attempt to penetrate the network using a deceptive computer element (e.g., false information, such as a bogus user account) introduced by the local proxy into the response.

In response to determining the unauthorized party has attempted to use the supplemental data, the operating system of the server can automatically create a Domain Name System (DNS) query and transmit the DNS query to a DNS server 110. The DNS server 110 creates and returns a DNS response that includes a failure header when the DNS server 110 determines that the DNS query cannot be satisfied. Responsive to determining the DNS response includes a failure header, the DNS response can be redirected to the local proxy, which determines whether the sought-after information included supplemental data injected into the response. If so, the local proxy can create a record of the event failure that can be subsequently analyzed.

Such a technique could make use of some security protocols that are already executed by the operating system of the server. For example, the server may already be configured to automatically create the failure event in response to determining the sought-after information does not actually exist. Moreover, while reference may be made above to a server, one skilled in the art will recognize that the techniques described herein are equally applicable to other network end points.

In at least one embodiment the supplemental data account can include a password that is easy to guess thereby allowing hackers to easily gain access to the system. Such supplemental data accounts can be configured to have minimal security settings. This configuration can allow the system to monitor the activity of the hackers who gained access to the system and determine the hacker's objective. This technique can also be used to gain information by requesting information from the hacker such as the operating system of the hacker's machine.

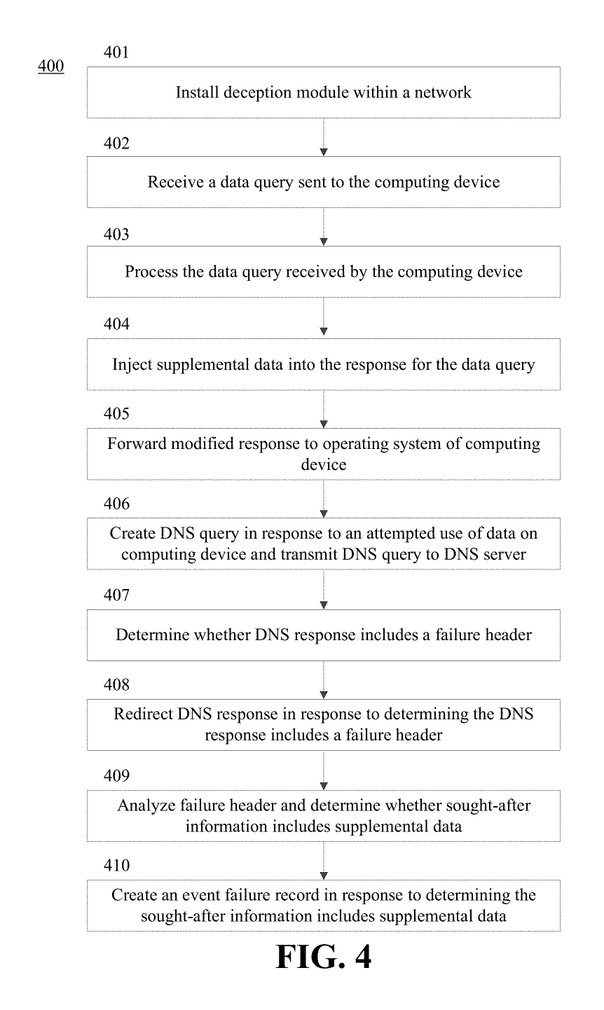

FIG. 4 depicts a flow diagram of a process 400 at a network computing device for injection of supplemental data into the results of a data query, such as a user account enumeration query. Initially, a deception module is installed within a network (step 401). The deception module could be included on a virtual machine that is installed, for example, on a computing device (e.g., a server or endpoint) that resides within the network. More specifically, installation of the deception module may require that modifications be made to the operating system installed on the network computing device. The computing device can then receive a data query, such as a user account enumeration query (step 402).

The computing device can then process the data query and may perform a system operation (step 403). For example, the computing device may read information from a directory server in response to receiving a user account enumeration query. Next, the operating system of the network computing device directs the response to the deception module (e.g., a local proxy). The deception module could then add supplemental data to the response generated by the directory server (step 404). The supplemental data may include false information (i.e., information not provided by the directory server), such as bogus user account information. The deception module then forwards the modified response back to the operating system of the network computing device for further processing (step 405). The addition of the supplemental data may not infringe upon the composition of the network as a whole or the ability of authorized users to continue legitimate use of the network. The security techniques described herein may be entirely or substantially unobservable/unnoticeable to authorized users of the internal network (e.g., employees of an enterprise).

As noted above, this technique could be used as part of a larger system to obfuscate hacking of the internal network. For example, the computing device and/or the deception module may subsequently track whether the supplemental data is used in an attempt to access the internal network. More specifically, the operating system of the computing device can automatically create a DNS query responsive to determining a user has attempted to use data hosted by the computing device, and transmit the DNS query to a DNS server (step 406).

The computing device will subsequently receive a DNS response from the DNS header. If the DNS query includes a request for supplemental data injected by the local proxy, the DNS response will include a failure header generated by the DNS server. Said another way, the DNS response will include a failure header when the DNS server determines that the DNS query cannot be satisfied because it includes a request for deceptive (e.g., non-authentic) data. Thus, after transmitting a DNS query to the DNS server, the operating system of the computing device can determine whether the DNS response includes a failure header (step 407).

Responsive to determining the DNS response includes a failure header, the DNS response can be redirected to the deception module for further analysis (step 408). The deception module can analyze the failure header and determine whether the sought-after information includes supplemental data (step 409). If the DNS request was for supplemental data, the local proxy can create a record of the event failure that can be subsequently analyzed (step 410). For example, event failure records can be used to identify whether the internal network is an attractive target for unauthorized parties, which network end point(s) have been targeted most often, which preventive measure(s) should be employed by the deception module, how often the internal network is targeted, etc.

### Computer System

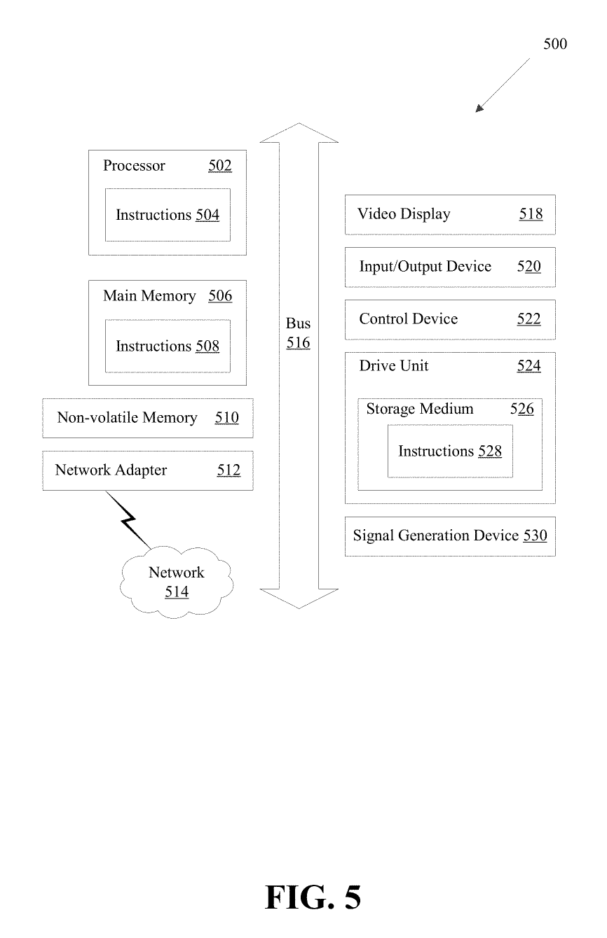

FIG. 5 is a block diagram illustrating an example of a computing system 500 in which at least some operations described herein can be implemented. The computing system may include one or more central processing units (“processors”) 502, main memory 506, non-volatile memory 510, network adapter 512 (e.g., network interfaces), video display 518, input/output devices 520, control device 522 (e.g., keyboard and pointing devices), drive unit 524 including a storage medium 526, and signal generation device 530 that are communicatively connected to a bus 516. The bus 516 is illustrated as an abstraction that represents any one or more separate physical buses, point to point connections, or both connected by appropriate bridges, adapters, or controllers. The bus 516, therefore, can include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire.”

In various embodiments, the computing system 500 operates as a standalone device, although the computing system 500 may be connected (e.g., wired or wirelessly) to other machines. In a networked deployment, the computing system 500 may operate in the capacity of a server or a client machine in a client-server network environment, or as a peer machine in a peer-to-peer (or distributed) network environment.

The computing system 500 may be a server computer, a client computer, a personal computer (PC), a user device, a tablet PC, a laptop computer, a personal digital assistant (PDA), a cellular telephone, an iPhone, an iPad, a Blackberry, a processor, a telephone, a web appliance, a network router, switch or bridge, a console, a hand-held console, a (hand-held) gaming device, a music player, any portable, mobile, hand-held device, or any machine capable of executing a set of instructions (sequential or otherwise) that specify actions to be taken by the computing system.

While the main memory 506, non-volatile memory 510, and storage medium 526 (also called a “machine-readable medium”) are shown to be a single medium, the term “machine-readable medium” and “storage medium” should be taken to include a single medium or multiple media (e.g., a centralized or distributed database, and/or associated caches and servers) that store one or more sets of instructions 528. The term “machine-readable medium” and “storage medium” shall also be taken to include any medium that is capable of storing, encoding, or carrying a set of instructions for execution by the computing system and that cause the computing system to perform any one or more of the methodologies of the presently disclosed embodiments.

In general, the routines executed to implement the embodiments of the disclosure, may be implemented as part of an operating system or a specific application, component, program, object, module or sequence of instructions referred to as “computer programs.” The computer programs typically comprise one or more instructions (e.g., instructions 504, 508, 528) set at various times in various memory and storage devices in a computer, and that, when read and executed by one or more processing units or processors 502, cause the computing system 500 to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include, but are not limited to, recordable type media such as volatile and non-volatile memory devices 510, floppy and other removable disks, hard disk drives, optical disks (e.g., Compact Disk Read-Only Memory (CD ROMS), Digital Versatile Disks, (DVDs)), and transmission type media such as digital and analog communication links.

The network adapter 512 enables the computing system 1000 to mediate data in a network 514 with an entity that is external to the computing device 500, through any known and/or convenient communications protocol supported by the computing system 500 and the external entity. The network adapter 512 can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

The network adapter 512 can include a firewall which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand.

Other network security functions can be performed or included in the functions of the firewall, and can include, but are not limited to, intrusion-prevention, intrusion detection, next-generation firewall, personal firewall, etc.

As indicated above, the techniques introduced here are implemented by, for example, programmable circuitry (e.g., one or more microprocessors), programmed with software and/or firmware, entirely in special-purpose hardwired (i.e., non-programmable) circuitry, or in a combination of such forms. Special-purpose circuitry can be in the form of, for example, one or more application-specific integrated circuits (ASICs), programmable logic devices (PLDs), field-programmable gate arrays (FPGAs), etc.

### Remarks

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling others skilled in the relevant art to understand the claimed subject matter, the various embodiments, and the various modifications that are suited to the particular uses contemplated.

Although the above Detailed Description describes certain embodiments and the best mode contemplated, no matter how detailed the above appears in text, the embodiments can be practiced in many ways. Details of the systems and methods may vary considerably in their implementation details, while still being encompassed by the specification. As noted above, particular terminology used when describing certain features or aspects of various embodiments should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless those terms are explicitly defined herein. Accordingly, the actual scope of the invention encompasses not only the disclosed embodiments, but also all equivalent ways of practicing or implementing the embodiments under the claims.

The language used in the specification has been principally selected for readability and instructional purposes, and it may not have been selected to delineate or circumscribe the inventive subject matter. It is therefore intended that the scope of the invention be limited not by this Detailed Description, but rather by any claims that issue on an application based hereon. Accordingly, the disclosure of various embodiments is intended to be illustrative, but not limiting, of the scope of the embodiments, which is set forth in the following claims.

1. A computer-implemented method, the method comprising:
causing a deception module to be installed on a computing device within a network;
receiving, via a processor, a data query from a sender;
transmitting the data query to a directory server that includes a main identity database;
receiving a response to the data query from the directory server;
generating a supplemental information based on the response to the data query, the supplemental information representing one or more data record not found in the main identify database;
generating a modified query response including the supplemental information representing a modified version of the response to the data query from the directory server; and
transmitting the modified query response to the sender of the data query.

2. The computer-implemented method of claim 1, wherein the computing device is a server or an endpoint.

3. The computer-implemented method of claim 1, wherein the network is an internal network associated with an enterprise.

4. The computer-implemented method of claim 1, wherein the data query is a user account enumeration query.

5. The computer-implemented method of claim 4, wherein the supplemental information includes a fictitious user account.

6. The computer-implemented method of claim 1, comprising generating the supplemental information, wherein generating the supplemental information includes analyzing a valid record.

7. The computer-implemented method of claim 6, wherein analyzing the valid record includes determining a format of the valid record.

8. The computer-implemented method of claim 7, wherein generating the supplemental information includes creating the supplemental information in a similar format as the format of the valid record.

9. The computer-implemented method of claim 8, wherein the format of the valid record is an arrangement of a portion of a first name in respect to a last name.

10. The computer-implemented method of claim 9, wherein the supplemental information includes a username and a password, wherein the password is a low strength password.

11. The computer-implemented method of claim 10, comprising storing the supplemental information in the main identity database.

12. A system for obfuscating unauthorized users attempting to penetrate a network, the system comprising:
an identity database configured to store a valid record used to facilitate a directory service for the network; and
a deception module that stored on a computing device within the network and configured to
receive a data query from a sender;
transmit the data query to a directory server that includes a main identity database;
receive a response to the data query from the directory server;
generate supplemental information based on the response to the data query, the supplemental information representing one or more data record not found in the main identify database;
generate a modified query response including the supplemental information representing a modified version of the response to the data query from the directory server; and
transmit the modified query response to the sender of the data query.

13. The system for obfuscating unauthorized users attempting to penetrate a network of claim 12, wherein the computing device is a server or an endpoint.

14. The system for obfuscating unauthorized users attempting to penetrate a network of claim 12, wherein the network is an internal network associated with an enterprise.

15. The system for obfuscating unauthorized users attempting to penetrate a network of claim 12, wherein the data query is a user account enumeration query.

16. The system for obfuscating unauthorized users attempting to penetrate a network of claim 15, wherein the supplemental information includes a fictitious user account.

17. The system for obfuscating unauthorized users attempting to penetrate a network of claim 12, wherein generating the supplemental information includes analyzing the valid record.

18. The system for obfuscating unauthorized users attempting to penetrate a network of claim 17, wherein analyzing the valid record includes determining a format of the valid record.

19. The system for obfuscating unauthorized users attempting to penetrate a network of claim 18, wherein generating the supplemental information includes creating the supplemental information in a similar format as the format of the valid record.

20. The system for obfuscating unauthorized users attempting to penetrate a network of claim 19, wherein the format of the valid record is an arrangement of a portion of a first name in respect to a last name.

21. The system for obfuscating unauthorized users attempting to penetrate a network of claim 20, wherein the supplemental information includes a username and a password, wherein the password is a low strength password.

22. The system for obfuscating unauthorized users attempting to penetrate a network of claim 21, comprising storing the supplemental information in the main identity database.
